(19) United States
(12) Patent Application Publication
(10) Pub. No.: US 2009/0245113 A1
(43) Pub. Date: Oct. 1, 2009

(54) LOAD BALANCER, NETWORK SYSTEM, LOAD BALANCING METHOD, AND PROGRAM

(75) Inventor: SATOSHI KAMIYA, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: NEC Corporation, Tokyo (JP)

(21) Appl. No.: 12/410,830

(22) Filed: Mar. 25, 2009

(30) Foreign Application Priority Data
Mar. 27, 2008 (JP) 2008-083674

(51) Int. Cl. H04J 3/14; G06F 15/16

(52) U.S. Cl. 370/238; 709/235

(57) ABSTRACT

In a load balancer and a load balancing method, if load on a server becomes higher and the server enters a high-load state, processing is transferred from the server to a second server. In a load balancer, for user terminals registered to SIP servers, a server as a register request destination is dynamically changed according to load on the user terminals, which makes it possible to transfer the processing to a low-load SIP server.

This application is based upon and claims the benefit of priority from Japanese patent application No. 2008-083674, filed on Mar. 27, 2008, the disclosure of which is incorporated herein in its entirety by reference.

### BACKGROUND OF THE INVENTION

1. Field of the Invention

The present invention relates to a load balancer, a network system, a load balancing method, and a program, and in particular, to a load balancer, a network system, a load balancing method, and a program favorably applicable to a communication network to carry out signaling by use of a Session Initiation Protocol (SIP).

2. Description of the Related Art

Recently, there has been broadly employed realtime communication using an Internet Protocol (IP) network as in Voice over IP (VoIP). The SIP is increasingly adopted as an international standard protocol in various situations, for example, to establish a connection between two end terminals such as telephone terminals and personal computers for realtime communication therebetween. In the present specification, a communication network to conduct signaling by use of the SIP is referred to as an SIP network.

The SIP network is generally configured as described in, for example, Japanese Patent Laid-Open Publication Ser. No. 2007-60210 and as shown in FIG. 3-2 “yuza ejento to SIP saba no kankei (relationship between user agent and SIP server)” in page 78 of “kaiteiban SIP kyokasho (revised edition SIP Textbook)” published from Inpuresu R&D.

An SIP network includes a location server, a SIP server, and a user agent (UA).

According to description in page 76 of the SIP Textbook, the SIP is based on a client-server model between end systems. The end system corresponds to a user agent. Each user agent is specifically an end system, e.g., a telephone or a personal computer. Services are implemented by communicating a request and a response between these end systems.

In this specification, the request and the response used in the above article will be referred to as “SIP request” and “SIP response”, respectively.

As described in page 77 of the SIP Textbook, the SIP server includes (a) a proxy server function to relay an SIP request and an SIP response, (b) a redirect server function to make a query for a destination of an SIP request, and (c) a registration server function to accept registration of positional information of a UA on the SIP network.

According to description in page 81 of the SIP Textbook, the location server accumulates information of UA maintained by the registration server to provide a database service which is used by the proxy server function and the redirect server function. Specifically, as described in page 112 of the SIP Textbook, the location server accumulates UA positional information by use of an SIP request, i.e., a Register request. In this specification, the UA positional information to be registered to the location service in response to the Register request is referred to as “register entry”.

As described in page 81 of the SIP Textbook, the SPI does not define any access method to access the location server, and hence no correspondence is defined between the SIP and location servers. Therefore, as described in Japanese Patent Laid-Open Publication Ser. No. 2007-60210, there exists a plurality of combinations of the SIP server and the location server. In a first model, one location server is shared among a plurality of proxy server functions. This is referred to as “share model”.

In a second model, the location server function is disposed in one SIP server. This is referred to as “exclusive model”.

As techniques for load balancing for SIP servers, particularly, the proxy server functions, there have been generally known schemes described in, for example, Japanese Patent Laid-Open Publication Ser. Nos. 2007-60210, 2007-4361, and 2007-221265.

That is, a load balancer includes a correspondence table including a correspondence between a value of a Call Identifier (Call-ID) header (also abbreviated as Call-ID) stored in an SIP request and an SIP server, particularly, a proxy server function as a distribution destination of the SIP request.

The load balancer extracts a Call-ID from the SIP request and searches the correspondence table using the Call-ID as a search key to retrieve an SIP server, particularly, a proxy server function.

The SIP request is transferred to the retrieved SIP server, i.e., the proxy server function (reference is to be made to Japanese Patent Laid-Open Publication Ser. Nos. 2007-60210, 2007-4361, and 2007-221265.

Also, Japanese Patent Laid-Open Publication Ser. No. 2007-60210 describes a load balancer for load balancing for the SIP servers. Even in an environment in which register entries indicating positional information of user terminals are distributed, the load balancer in use with SIP servers of the exclusive model identifies at a high speed a server in which the register entry of a user terminal exists, obtains the register entry from the associated server, and then stores the entry in a server as the distribution destination. As a result, a call connection request is processed in the server as the transferring destination.

Japanese Patent Laid-Open Publication Ser. No. 2007-4361 describes a load balancer for SIP servers. When the load balancer is used with SIP servers of the exclusive model, a register entry indicating positional information of one and the same user terminal is registered to all SIP servers. The load balancer connected via a network to a plurality of SIP servers and a plurality of SIP terminals includes a registration request identifying section to identify a registration request to an SIP server, a registration request copy section to copy a registration request from an identified SIP terminal, a distribution controller to deliver the copy of the registration request to all SIP servers, a distribution information manager to manage priority connection server information of an SIP terminal, and an SIP server load monitor section to monitor a load imposed on each SIP server. If load imposed on a priority connection server associated with the SIP terminal issuing a call is low, the distribution controller transfers a session from the SIP terminal to the priority connection server.

Japanese Patent Laid-Open Publication Ser. No. 2007-221265 describes a load balancer for use with a system to conduct session management by using three SIP servers, i.e., a Proxy Call Session Control Function (P-CSCF) server, an Interrogating Call Session Control Function (I-CSCF) server, and a Serving Call Session Control Function (S-CSCF) server in an IP Multimedia Subsystem (IMS) being standardized by the 3rd Generation Partnership Project (3GPP) as an institute to standardize the third-generation mobile communication systems. This system adopts a configuration of an exclusive model in which a register entry is individually and distributively allocated to the S-CSCF.

### SUMMARY OF THE INVENTION

The disclosure of each of Japanese Patent Laid-Open Publication Ser. Nos. 2007-60210, 2007-4361, and 2007-221265 and the SIP Textbook is incorporated herein by reference. The techniques of the disclosures will now be analytically described.

A first problem resides in that for SIP server of the exclusive model, the correspondence between the SIP UA and SIP servers to execute processing is fixedly determined in the register processing. Hence, even if the load imposed on the associated SIP server becomes higher, it is not possible to hand over the processing to another SIP server.

For an SIP server of the exclusive model, when the SIP UA issues a register request, a server to which a register entry is to be registered is determined.

The SIP server executes not only the processing of the register entry, but also session initiating, keeping, and terminating processings which are initiated using “invite”, namely call initiation processing, and terminated using “bye”. For the associated SIP server, one SIP UA registered to the SIP server may cause a plurality of session processings. This possibly results in a situation wherein the SIP server must execute session processings the number of which is in proportion to an integral multiple of the number of SIP UA registered thereto.

For “invite” response, namely, call termination processing, the associated SIP server receives “invite” via a second SIP server from an SIP UA not having a register entry. It is required for the associated SIP server to relay the “invite” to an SIP UA under control thereof.

The load balancer conceals results of registration, therefore each SIP UA cannot recognize to which one SIP server it has been registered. Even in a situation wherein the SIP server to which the SIP UA is belonging enters a high-load state, if the SIP UA issues a new “invite”, the server is required to execute processing for the “invite” in this state.

In this case, even if a second SIP server coupled with the same load balancer is in a low-load state, since information of registration by “register” of the associated SIP UA is not available, the processing cannot be transferred to the second SIP server.

It is therefore an exemplary object of the present invention to provide a load balancer, a network system, a load balancing method, and a program wherein when a plurality of servers are coupled via a load balancer to user terminals, the registry processing can be dynamically transferred between the servers for load balancing.

To achieve the exemplary object, the present invention has exemplary aspects as follows.

In accordance with one exemplary aspect of the present invention, there is provided a load balancer for monitoring load on a plurality of servers connected to a network and for thereby distributing load to the servers, wherein when a server having load equal to or more than a predetermined threshold value is detected and if there exists a user terminal which is registered to the server and which is not connected thereto for a session, the load balancer changes registration of the user terminal from the server to a second server having load less than the predetermined threshold value.

In accordance with the present invention, there is provided a network system including the load balancer to distribute load to a plurality of servers.

In accordance with one exemplary aspect of the present invention, there is provided a load balancing method of monitoring load on a plurality of servers connected to a network and for thereby distributing load to the servers, wherein when a server having load equal to or more than a predetermined threshold value is detected and if there exists a user terminal which is registered to the server and which is not connected thereto for a session, the method including: changing registration of the user terminal from the server to a second server having load less than the predetermined threshold value.

In accordance with one exemplary aspect of the present invention, there is provided a program for making a computer, included in a load balancer for monitoring load on a plurality of servers connected to a network and for thereby distributing load to the servers, execute processing including: when a server having load equal to or more than a predetermined threshold value is detected and if there exists a user terminal which is registered to the server and which is not connected thereto for a session, changing registration of the user terminal from the server to a second server having load less than the predetermined threshold value.

### BRIEF DESCRIPTION OF THE DRAWINGS

The exemplary objects and features of the present invention will become more apparent from the consideration of the following detailed description taken in conjunction with the accompanying drawings in which:

FIG. 1 is a schematic block diagram showing a configuration of an exemplary embodiment in accordance with the present invention;

FIG. 2 is a flowchart showing an example of processing in a message analysis section of the exemplary embodiment;

FIG. 3 is a flowchart showing an example of processing in a distribution destination determining section of the exemplary embodiment;

FIG. 4 is a flowchart showing an example of processing in a “register” entry storing section of the exemplary embodiment;

FIG. 5 is a flowchart showing an example of processing in a message communication section of the exemplary embodiment;

FIG. 6 is a flowchart showing an example of processing in a “register” entry transfer indication section of the exemplary embodiment; and

FIG. 7 is a sequence chart showing sequences employed by a UA to execute “register” processing and “register” transfer indication processing in the exemplary embodiment.

### DESCRIPTION OF THE EXEMPLARY EMBODIMENTS

Referring next to the accompanying drawings, description will be given in detail of the present invention. For example, based on load information of the servers periodically acquired therefrom, a storage having stored a transfer destination of a call connection request message is changed to thereby update, i.e., to add or to delete registration information for associated servers. In a situation wherein the load imposed on each of the servers varies, when call connection processing is restricted to a particular server by the registration information and the server is in a high-load state, the processing is transferred to a second server with a lower load. This resultantly improves imbalance in the processing load among a plurality of servers to thereby increase processing performance of the servers.

In accordance with the present invention, when the load balancer monitoring load on a plurality of servers coupled with a network detects a server having a load equal to or more than a predetermined threshold value and if there exists a user terminal which is registered to the server and which has not been connected thereto for a session, the registration of the user terminal is changed from the server with a load equal to or more than a predetermined threshold value to a server with a load less than the predetermined threshold value. Description will now be given in detail of an exemplary embodiment of the present invention.

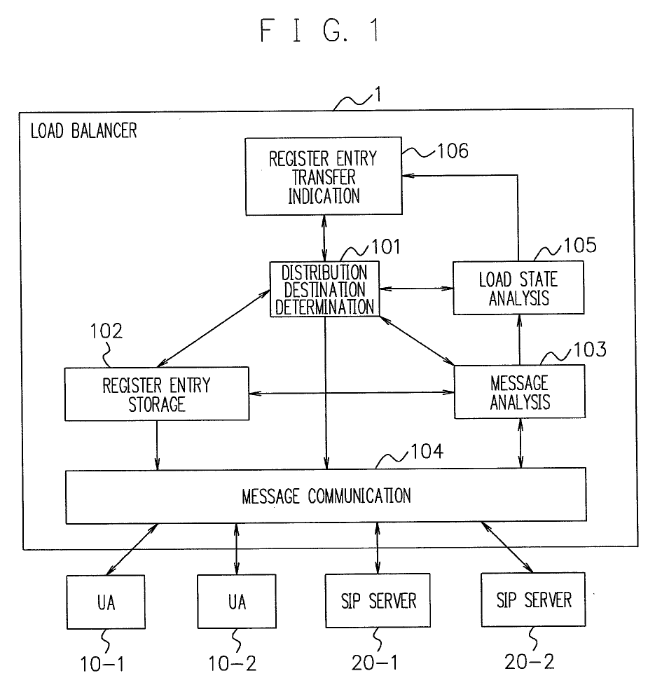

FIG. 1 shows a configuration of an exemplary embodiment in accordance with the present invention. The configuration includes an SIP network including a load balancer 1.

The load balancer 1 is coupled via a network to a plurality of User Agents (UA; user terminals) 10-1 and 10-2 and a plurality of SIP servers 20-1 and 20-2. Although the system includes two UAs and two SIP servers in FIG. 1, there may be disposed three or more UAs and three or more SIP servers.

The load balancer 1 includes an SIP server distribution destination determining section (a distribution determining section of the claims) 101, a register entry storage section (a positional information registering section of the claims) 102, a message analyzer section 103, a message communication section (communication interface) 104, a load state analyzer section 105, and a register entry transfer indication section (register information transfer section of the claims) 106.

The distribution destination determining section 101 includes functions as below.
(a1) The distribution destination determining section 101 analyzes a type of an SIP packet sent from the UA 10-1 or 10-2 or the SIP server 20-1 or 202 and distributes the SIP request, e.g., a register request or an invite request to resultantly select an SIP server.
(a2) The distribution destination determining section 101 requests the resister entry storage section 102 to store a register entry on a reception-side UA in an SIP server as the distribution destination.
(a3) The distribution destination determining section 101 requests the message communication section 104 to transfer the SIP request to the SIP server as the distribution destination.
(a4) The distribution destination determining section 101 manages information (to be referred to as distribution information) which is referred to in an operation to select an SIP server as the distribution destination of the SIP request.
(a5) The distribution destination determining section 101 executes transfer processing to transfer a register entry of a UA to the SIP server indicated from the register entry transfer indication section 106.

In this connection, an example of distribution information will be described later in detail.

The resister entry storage section 102 includes functions as follows.
(b1) The resister entry storage section 102 issues a query to the SIP server selected by the distribution destination determining section 101 to determine whether or not the server has stored a register entry (positional information registration) of the reception-side UA.
(b2) The resister entry storage section 102 identifies an SIP server to store a register entry of a reception-side UA.
(b3) The resister entry storage section 102 attains a register entry of the reception-side UA to store the register entry in an SIP server selected by the distribution destination determining section 101.

The message analyzer section 103 includes functions as below.
(c1) The message analyzer section 103 analyzes a type of an SIP packet transferred from the message communication section 104 to determine a type of a message having stored an SIP request or an SIP response, for example, “180 Ringing” or “200 OK”.
(c2) The message analyzer section 103 transmits an SIP request to the distribution destination determining section 101.
(c3) The message analyzer section 103 transmits, in response to an SIP request received from the load balancer 1, an SIP reply to the register entry storage section 102.
(c4) The message analyzer section 103 transmits, in response to other than the SIP request received from the load balancer 1, an SIP reply to the message communication section 104.
(c5) The message analyzer section 103 notifies the load state analyzer section 105 of load information of a server sent from an SIP server.

The message communication section 104 includes the following functions.
(d1) The message communication section 104 receives a message, i.e., an SIP request or response from a UA or an SIP server.
(d2) The message communication section 104 transmits a message, namely, an SIP request or response to the UA or the SIP server designated by the distribution destination determining section 101.
(d3) The message communication section 104 receives a message, namely, an SIP request or response from the UA or the SIP server and transmits the message to the message analyzer section 103.

The load state analyzer section 105 includes functions as below.
(e1) The load state analyzer section 105 manages load information which is sent from each SIP server and which is notified via the message analyzer section 103, and notifies the distribution destination determining section 101 of distribution information created on the basis of the load information.
(e2) The load state analyzer section 105 notifies the register entry transfer indication section 106 of information (to be referred to as entry transfer SIP server information) of an SIP server as a candidate for execution of an entry transfer based on the load information.

The register entry transfer indication section 106 includes the following functions.
(f) The register entry transfer indication section 106 notifies the distribution destination determining section 101 of an SIP server as a register entry transfer target by use of the entry transfer SIP server information from the load state analyzer section 105 and information of a UA which has a register entry in an SIP server included in the entry transfer SIP server information acquired from the distribution destination determining section 101 and for which call processing is not being executed by the SIP server.

It is possible that the functions and processings of the respective sections 101 to 106 are implemented by use of a program which operates on a computer forming part of the load balancer 1.

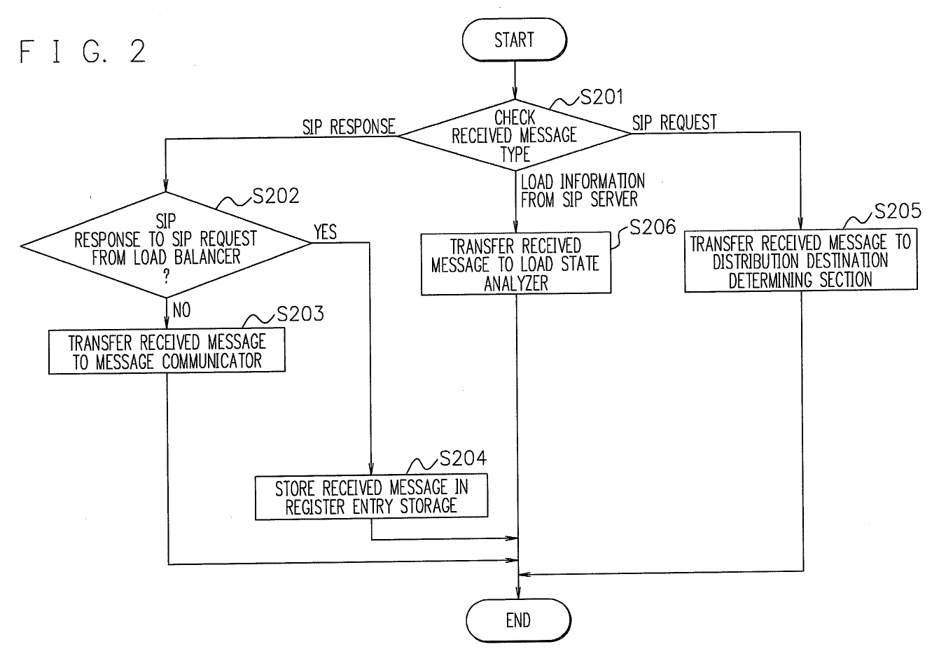

Next, operation of the load balancer 1 will be described in accordance with the exemplary embodiment. FIG. 2 is a flowchart of processing in the message analyzer section 103 of the load balancer 1.

Assume that the message analyzer section 103 receives a message via the message communication section 104 from a UA or an SIP server.

The message analyzer section 103 makes a check to determine a type of the received message (step S201).

If it is determined that the message is an SIP request, e.g., an invite request for call connection or a register request for positional information registration, the message analyzer section 103 transfers the message to the distribution destination determining section 101 (step S205).

If the message is an SIP response, e.g., “180 Ringing” or “200 OK” in step S201, the message analyzer section 103 further determines whether or not the IP response is a response to an SIP request from the load balancer 1 (step S202). Description will be given of an example of this processing.

For example, to issue a register request, the register entry storage section 102 beforehand transfers, to the message analyzer section 103, an identifier (call ID) to be added to the register request. The identifier may include any character string, for example, may be the same as an identifier of an invite request or an identifier created by adding a symbol thereto.

The message analyzer section 103 checks the call ID of the message from the message communication section 104. If the call ID matches that beforehand notified from the register entry storage section 102, the message analyzer section 103 determines that the message is an SIP response to an SIP request issued from the load balancer 1.

If it is determined in step S202 that the received SIP response is a response to an SIP request from the load balancer 1, the message analyzer section 103 transfers the message to the register entry storage section 102 (step S204).

In step S202, if the received SIP response is other than the SIP response to an SIP request from the load balancer 1, the message analyzer section 103 transfers the message to the message communication section 104 (step S203).

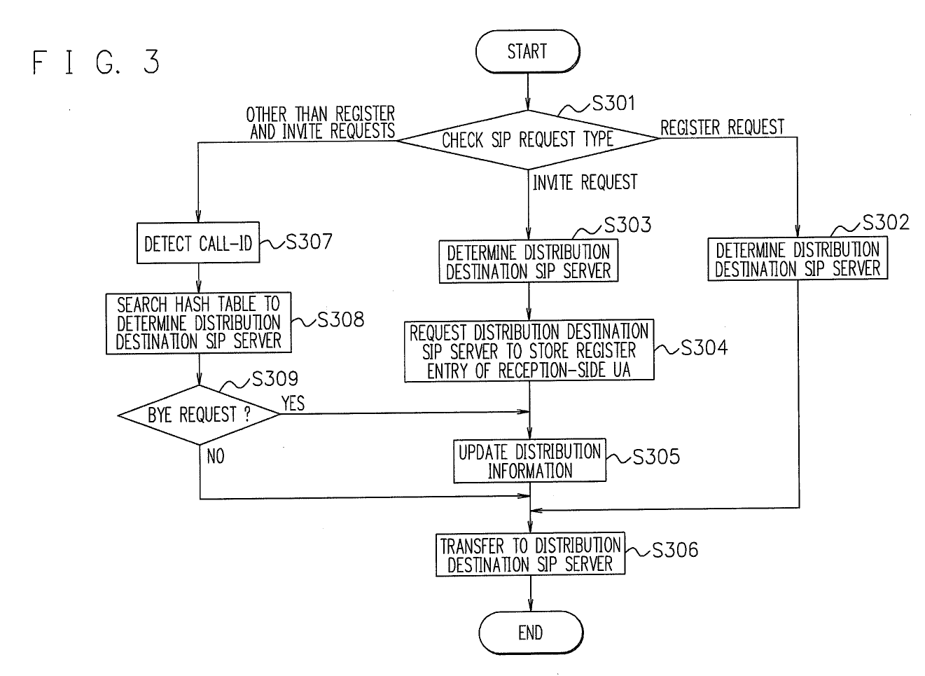

FIG. 3 is a flowchart showing processing in the destination determining section 101 of the load balancer 1. Assume that the section 101 receives an SIP request from the message analyzer section 103.

The determining section 101 checks the type of the SIP request (step S301).

If it is determined as a result of the check in step S301 that the received SIP request is a register request, the destination determining section 101 determines an SIP server as a distribution destination of the register request (step S302).

In this connection, an SIP server as the destination to transfer an SIP request from the load balancer 1 is referred to as a distribution destination SIP server.

Description will now be given of an example of processing in step S302.

For example, the destination determining section 101 obtains a search or retrieval key, e.g., an Address of Record (AoR) from a “to header” of the register request or a telephone number in an SIP Uniform Resource Identifier (URI) of a “contact header” of the request. An SIP URI including a telephone number is expressed in general as sip:phone-number@domain-name. If the identifier of an SIP server as the destination object is to be a positive integer less than the number of SIP servers as destination objects, the section 101 converts the search key into a positive integer, divides the integer by the number of SIP servers to obtain the remainder, and determines an SIP server indicated by the remainder as the distribution target.

If the SIP request is an invite request in step S301, the section 101 determines an SIP server as the destination object of the invite request (step S303). This processing is executed, for example, as follows.

The destination determining section 101 acquires as a search key, for example, an AoR or a call-ID from a “from header” of the invite request. Subsequent processing is similar to the processing to determine a SIP server as the distribution destination of the register request.

The processing of step S303 may be executed as below. That is, the section 101 detects a least loaded SIP server to determine the SIP server as the destination.

The determining section 101 notifies the register entry storage section 102 of the identifier of the destination SIP server attained in step S303 and the AoR obtained from the “to header” of the received invite request, to thereby request the register entry storage section 102 to store a register entry of a reception-side UA in the destination SIP server (step S304).

If the received SIP request from the message analyzer section 103 is neither a register request nor an invite request, but is, for example, an ack request or a bye request in step S301, the destination determining section 101 extracts a call ID from the SIP request (step S307).

Using the call ID as a search key, the section 101 searches a hash table having stored data pairs each including a call ID and an identifier of a destination SIP server (step S308).

The section 101 then determines whether or not the SIP request checked in step S301 is a bye request (step S309). If the SIP request is a bye request or if the storage request of the register entry has been completely processed as a result of step S304, the section 101 updates distribution information (step S305).

The distribution information includes the hash table used in step S308. In a situation wherein SIP server load information from the load state analyzer section 105 is employed to determine the destination SIP server in step S303, the information further includes the SIP server load information.

The destination determining section 101 updates the hash table as below.

If the SIP request is an invite request in step S301, the section 101 stores in the hash table a data pair including a call ID obtained from the invite request and a destination SIP server determined in step S303.

If the SIP request is a bye request in step S309, the destination determination section 101 deletes an entry including a data pair of the call ID stored in the bye request from the hash table.

If the destination SIP server is determined in step S302, if the update of the distribution information is finished in step S305, or if the SIP request is other than a bye request in step S309, the section 101 requests the message communication section 104 to transfer the received message to the destination SIP server determined as a result of step S302, S303, or S308 (step S306).

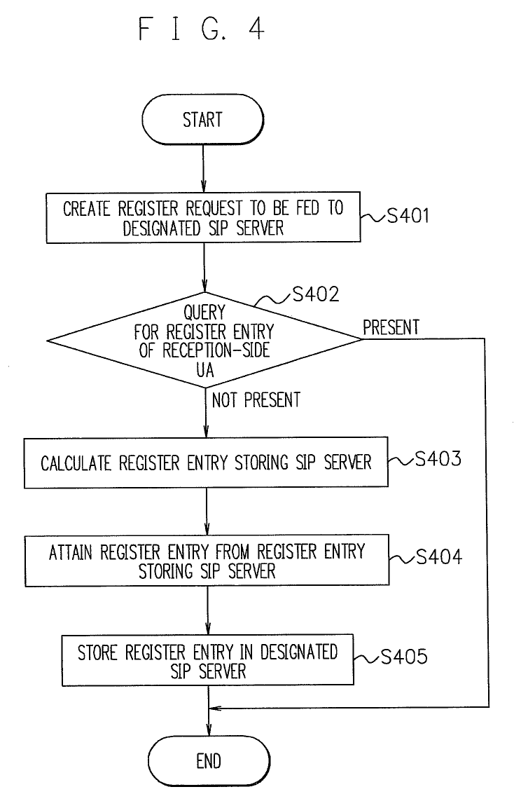

FIG. 4 is a flowchart showing processing of the register entry storage section 102. Assume that the register entry storage section 102 has received from the destination determining section 101 an identifier of the destination SIP server and an AoR stored in the “to header” of the invite request to indicate the reception-side UA.

The register entry storage section 102 creates a register request to be transmitted to the designated SIP server (step S401). This processing is achieved by inserting the AoR from the determining section 101 in the “from header” and the “to header”, setting “random-character-string@IP-address-of-load balancer-1” as the Call ID, and setting “1 register” as the CSeq header.

The register entry storage section 102 requests the message communication section 104 to transmit the register request created in step S401 to the SIP server specified by the determining section 101 to thereby inquire the destination SIP server whether or not a register entry exists for the reception-side UA (step S402).

The register entry storage section 102 notifies the message analyzer section 103 of the call ID generated in step S401.

If it is determined in step S402 that the register entry of the reception-side UA does not exist in the destination SIP server, the register entry storage section 102 determines through calculation an SIP server to store the register entry of the reception-side UA (step S403).

The storage determines whether or not the register entry of the reception-side UA exists in the destination IP server, for example, as below.

If an SIP response which includes the call ID transmitted to the message analyzer section 103 and which is sent therefrom is “200 OK” in step S402, the register entry storage section 102 is capable of determining, since the register entry has been successfully retrieved in the associated SIP server, that the register entry of the reception-side UA is present in the destination SIP server.

If the SIP response is other than “200 OK”, it is possible for the register entry storage section 102 to determine that the register entry is absent from the destination SIP server.

The SIP server having stored the register entry can be determined through calculation as below. By using the AoR from the determining section 101 as an input, the register entry storage section 102 executes processing similar to the processing to determine through calculation the SIP server to which the register request is to be distributed.

From the SIP server which has stored the register entry of the reception-side UA and which is determined in step S403, the register entry storage section 102 acquires the register entry of the reception-side UA (step S404). This is carried out, for example, as follows.

The register entry storage section 102 creates a register request to be sent to the SIP server having stored the register entry of the reception-side UA, in almost the same way as for the processing to create the register request in step S401.

The register entry storage section 102 transfers the created register request and an identifier of the SIP server which has stored the register entry of the reception-side UA and which is determined in step S403, to the message communication section 104.

In step S404 as in step S402, the register entry storage section 102 notifies the call ID created in step S404 to the message analyzer section 103.

The register entry storage section 102 registers to the destination SIP server the register entry of the reception-side UA obtained in step S404 (step S405). This processing is executed, for example, as below.

As in step S401, the register entry storage section 102 creates the register request by inserting the AoR sent from the determining section 101 in the “from header” and the “to header”, setting “random-character-string@IP-address-of-load balancer-1” as the call-ID, and setting “1 register” as the CSeq header.

The register entry storage section 102 inserts the contact header of the register entry attained in step S404 in the contact header field of the request.

The register entry storage section 102 then transmits the register request to the message communication section 104 by designating the destination SIP server as the destination of the request.

The register entry storage section 102 terminates the processing if it is determined, as a result of the query of the register entry of the reception-side UA in step S402, that the register entry of the reception-side UA exists in the SIP server notified from the destination determining section 101 or if the register entry is stored in the reception-side SIP server in step S405.

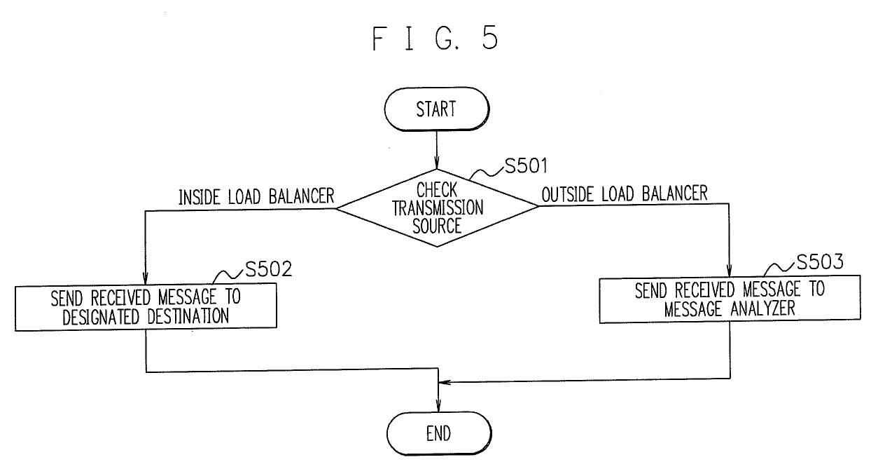

FIG. 5 shows processing of the message communication section 104 in a flowchart. Assume that the message communication section 104 has received a message.

The message communication section 104 makes a check to determine the transmission source of the message (step S501), for example, as below. If the message communication section 104 is called using a function call, it is determined that the message is sent from a component inside the load balancer. If the message communication section 104 is called via the SIP network, it is determined that the message is delivered from a device outside the load balancer.

If it is determined as a result of step S501 that the message is received from the inside of the load balancer, the message communication section 104 delivers the message to a designated destination (step S502).

If it is determined in step S501 that the message is received from the outside of the load balancer, the message communication section 104 sends the message to the message analyzer section 103 (step S503).

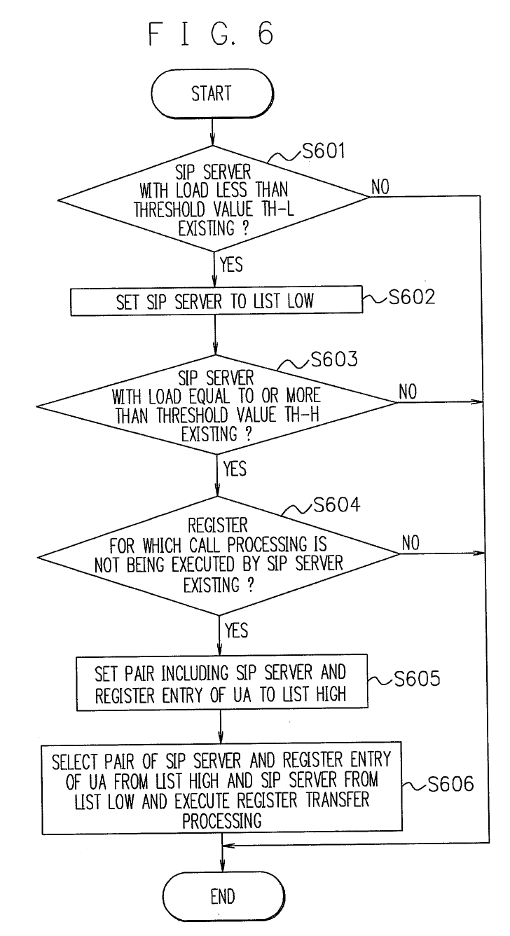

FIG. 6 is a flowchart showing processing of the register entry transfer indication section 106.

Using information of each SIP server from the load state analyzer section 105, the register entry transfer indication section 106 makes a check to determine whether or not there exists an SIP server having load more than an available low threshold value th-l (step S601). If such SIP server does not exist, the register entry transfer indication section 106 terminates the processing.

If such SIP server exists, the register entry transfer indication section 106 sets the server to a low-load server transfer candidate list Low (step S602).

Then, the register entry transfer indication section 106 makes a check to determine whether or not there exists an SIP server having load more than an available high threshold value th-h (step S603). If such SIP server does not exist, the register entry transfer indication section 106 terminates the processing.

If such SIP server exists, the register entry transfer indication section 106 makes a check to determine, based on session keep information from the destination determining section 101, whether or not there exists a register request of a UA for which call processing is not being processed by the associated SIP server (step S604). If such “register” is absent, the register entry transfer indication section 106 terminates the processing.

If such “register” is present, the register entry transfer indication section 106 sets a data pair including the SIP server and the register entry of the UA to a high load server transfer register list High (step S605).

The register entry transfer indication section 106 searches the high load server transfer register list High for a data pair including a high-load SIP server and a UA register entry and searches the low load server transfer candidate list Low for a high-load SIP server, a UA register entry, and a low-load SIP server as the register transfer processing object. Thereafter, the register entry transfer indication section 106 then indicates the distribution destination determining section 101 to execute register transfer processing.

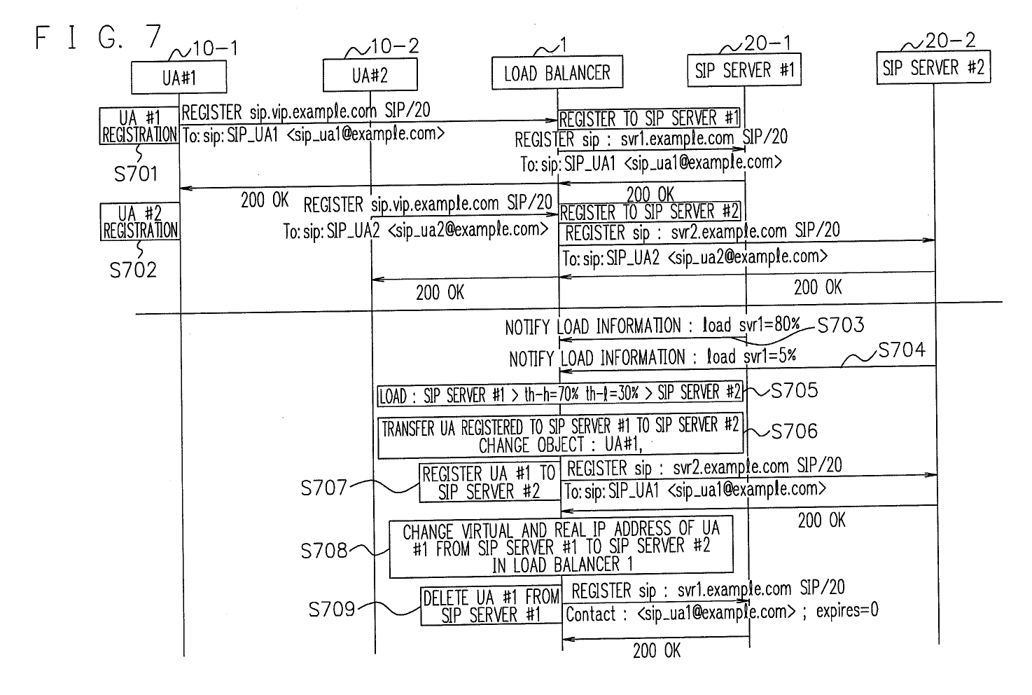

FIG. 7 is a sequence chart showing “register” entry processing and “register” transfer processing in the SIP network configured as shown in FIG. 1 and a sequence to change register information based on SIP server load.

It is assumed in FIG. 7 that the UA 10-1 has an SIP URI of “sip_ua1@example.com”, the UA 10-2 has an SIP URI of “sip_ua2@example.com”, an SIP server executing a transfer operation in the load balancer has a virtual IP address of “vip.example.com”, an SIP server #1 20-1 has a real IP address of “svr1.example.com”, and an SIP server #2 20-2 has a real IP address of “svr2.example.com”.

Step S701 is “registration of UA #1 10-1” and shows a sequence in which the load balancer 1 registers UA #1 10-1 to the SIP server #1 20-1.

Step S702 is a sequence of “registration of UA #2 10-2” in which the load balancer 1 registers UA #2 10-2 to the SIP server #2 20-2.

Step S703 and subsequent steps show a sequence of processing to transfer register information based on load imposed on the SIP servers.

The SIP server #1 20-1 notifies “80%” indicating a value of load, i.e., load information to the load balancer 1 (step S703).

The SIP server #2 20-2 notifies “5%” indicating a value of load as load information to the load balancer 1 (step S704).

Assume that the load balancer 1 sets, for example, 70% and 30% respectively to the high-level threshold value th-h and the low-level threshold value th-l.

As a result, the load balancer 1 determines that the SIP server #1 20-1 is in a high-load state and the SIP server #2 20-2 is in a low-load state (step S705).

For the UA #1 10-1, if no session processing has been registered in the SIP server #1 and the session is a transferable session, the load balancer 1 transfers the UA #1 10-1 from the SIP server #1 20-1 to the SIP server #2 20-2 (step S706).

In the sequence of step S707, the register information of the UA #1 10-1 is registered to the SIP server #1 20-1.

In step S708, the virtual and real IP addresses of the UA #1 10-1 are changed from the SIP server #1 20-1 to the SIP server #2 20-2 in the load balancer 1.

In the sequence shown in step S709, the register information of the UA #1 10-1 is deleted from the SIP server #2 20-2.

As a result of the processing, the register information of the UA #1 10-1 is completely transferred from the SIP server #1 20-1 to the SIP server #2 20-2.

That is, according to the load imposed on the SIP servers coupled with the load balancer 1, the load balancer 1 of the exemplary embodiment can update the SIP server having conducted the UA registration. Therefore, if the SIP server associated with a new SIP session enters a high-load state, the load balancer 1 transfers the session to a second SIP server so that the session is carried out by the second SIP server.

Description will now be given of advantages of the exemplary embodiment.

The processing of “register” requests from SIP user agents (UA) can be transferred among a plurality of SIP servers coupled via the load balancer to each other. Hence, if the load on a particular SIP server becomes higher and enters a high-load state, the session processing of the UA registered to the SIP server can be transferred to another SIP server with a lower load. It is resultantly possible to uniformly distribute the processing load to the SIP servers in the SIP system to thereby improve the overall system performance.

In accordance with Japanese Patent Laid-Open Publication Ser. Nos. 2007-4361, although a user terminal is registered by “register” according to the load imposed on SIP servers, the user terminal registration is accomplished only when the user terminal is activated and a registration request frame is copied to be registered to all SIP servers for load balancing. That is, each SIP server keeps the information of the user terminal registration in a duplicated fashion. This consequently increases the amount of data which is registered to be kept in the SIP servers.

In the exemplary embodiment, the information is first registered to only one server. After the registration, the amount of data to be kept in the system is less than that of data kept in accordance with the Japanese Patent Laid-Open Publication Ser. No. 2007-4361. According to the technique of the article, at detection of a session start frame, i.e., “invite”, the system selects a target SIP server for the “invite” from the servers by use of a round robin algorithm or from servers assigned with a relatively smaller number of sessions being in connection. In contrast therewith, according to the technique of the exemplary embodiment, the system monitors a plurality of servers coupled with a network to distribute load to the servers. At detection of a server assigned with load equal to or more than a predetermined threshold value, the system selects registration of a user terminal which has been registered to the server and for which no session has been established with respect to the server. The system then changes the registration of the user terminal to a server having load less than the threshold value.

The load balancer in accordance with the exemplary invention is applicable to an SIP network including a plurality of user terminals and a plurality of SIP servers.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined claims.

What is claimed is:

1. A load balancer for monitoring load on a plurality of servers connected to a network and for thereby distributing load to the servers, wherein
when a server having load equal to or more than a predetermined threshold value is detected and if there exists a user terminal which is registered to the server and which is not connected thereto for a session, the load balancer changes registration of the user terminal from the server to a second server having load less than the predetermined threshold value.

2. The load balancer in accordance with claim 1, comprising:
a message analyzing section for examining a message received from the network and detecting a call connection request issued from a user terminal on a transmission-side;
a server distribution section for selecting, according to a predetermined algorithm, a server to process the call connection request and transferring the call connection request to the server thus selected;
a distribution destination determining section for searching, using an address of a user terminal on a reception-side of the call connection request as a search key, a positional information registration section which stores an address of the user terminal and a server including positional information registration of the user terminal with a correspondence established therebetween, and thereby determining a server including the positional information registration of the reception-side user terminal; and
a registration information transfer section for controlling a change in the correspondence between the address of the user terminal and the server including the positional information registration of the user terminal, on the basis of load information of the servers and according to a predetermined algorithm.

3. A load balancer which is coupled via a network to a plurality of user terminals communicating via a network with each other and which is connected via a network to a plurality of servers each including a function to interface the communication and a positional information registration function to register positional information of the user terminal, the load balancer at least selecting a server to process interface of communication and for thereby distributing load to the servers, comprising:
a message analyzing section for examining a message received from the network and detecting a call connection request message issued from a user terminal on a transmission-side;
a server distribution section for selecting, according to a predetermined algorithm, a server to process the call connection request message and transferring the call connection request message to the server thus selected;
a distribution destination determining section for searching, using an address of a user terminal on a reception-side of the call connection request message as a search key, a positional information registration section which stores an address of the user terminal and a server including positional information registration of the user terminal with a correspondence established therebetween, and thereby determining a server including the positional information registration of the reception-side user terminal; and
a registration information transfer section for examining a message received from the network, periodically obtaining load information of the servers, and controlling a change in the correspondence between the address of the user terminal and the server including the positional information registration of the user terminal, on the basis of the load information of the servers and according to a predetermined algorithm.

4. The load balancer in accordance with claim 2, further comprising a load state analyzing section for managing the load information from the servers, notifying the distribution destination determining section of distribution information based on the load information, and notifying the registration information transfer section of information of a server as a candidate to which a transfer of an entry is to be executed on the basis of the load information.

5. The load balancer in accordance with claim 2, wherein the message analyzing section:
examines, at reception of a message sent from the user terminal or the server by a message communication section, a type of the message;
transfers the message to the distribution destination determining section if the message is a request;
makes a check, if the message is a reply, to determine whether or not the reply is a reply in response to a request issued from the load balancer;
examines a call identifier included in the message from the message communication section;
judges that the reply is a reply in response to the request issued from the load balancer if the call identifier matches call identifier information beforehand notified from the positional information registration section;
transfers the message to the positional information registration section if it is judged that the reply is a reply in response to the request; and
transfers the message to the message communication section if it is judged that the reply is other than a reply in response to the request.

6. The load balancer in accordance with claim 2, wherein the distribution destination determining section:
receives a request from the message analyzing section and examines a type of the request;
determines, if the request is a registration request, a server as a distribution destination of the registration request;
determines, if the request is a call connection request, a server as a distribution destination of the call connection request and requests the positional information registration section to store registration information of a user terminal on a reception-side in the server as a distribution destination, to thereby update distribution information;
extracts a call identifier from the request, if the type of the request is neither a registration request nor a call connection request, and searches a table having stored data pairs each including a call identifier and a distribution destination server to determine a distribution destination server as a distribution destination of the request;
updates the distribution information if the request is a termination request; and
instructs a message communication section to transfer the message to the distribution destination server.

7. The load balancer in accordance with claim 2, wherein the positional information registration section:
creates a registration request to be sent to a designated server;
notifies a message communication section to transmit the request to a distribution destination server designated by the distribution destination determining section;
issues a query to the distribution destination server to determine whether or not registration information of a reception-side user terminal exists in the distribution destination server;
determines, if the registration information is absent, through calculation a server storing the registration information of the reception-side user terminal;
obtains the registration information of the reception-side user terminal from the server of the reception-side user terminal; and
registers the registration information of the reception-side user terminal to the distribution destination server.

8. The load balancer in accordance with claim 2, wherein a message communication section:
examines a transmission source of a message;
sends, if it is determined that the message is from the inside of the load balancer, the message to a designated destination; and
sends, if it is determined that the message is from the outside of the load balancer, the message to the message analyzing section.

9. The load balancer in accordance with claim 2, wherein the registration information transfer section:
makes a check, based on information of the servers from a load state analyzing section, to determine presence or absence of a server having load equal to or less than a first available threshold value;
sets, if the server is present, the server to a low-load server transfer candidate list;
makes a check to determine presence or absence of a server having load equal to or more than a second available threshold value;
makes a check, if the server is present, to determine, based on session keep information from the distribution destination determining section, whether or not a user terminal for which call processing has not been executed in the server has been registered thereto;
sets, if the user terminal has been registered, a data pair including the server and registration information of the user terminal to a high-load server transfer registration list;
selects a high-load server as an object of registration information transfer processing, registration information of a user terminal, and a low-load server from the data pairs each including a high-load server and registration information of a user terminal in the high-load server transfer registration list and the servers in the low-load server transfer candidate list; and
instructs the distribution destination determining section to execute transfer processing.

10. The load balancer in accordance with claim 2, further comprising:
a positional information registration section;
a message communication section; and
a load state analyzing section, wherein the distribution destination determining section:
analyzes a type of a packet sent from a user terminal or a server and distributes a request to select a server;
requests the positional information registration section to store registration information of a user terminal on a reception-side in the server as a distribution object;
requests the message communication section to transfer the request to the server as a distribution object;
manages distribution information which is referred to when a server as a distribution object of a request is selected; and
executes registration information transfer processing of the user terminal for the server indicated by the registration information transfer section.

11. The load balancer in accordance with claim 2, wherein:
a positional information registration section
issues a query to the server selected by the distribution destination determining section to determine whether or not the server has stored the registration information of the reception-side user terminal,
identifies a server storing the registration information of the reception-side user terminal, and
obtains the registration information of the reception-side user terminal and stores the information in the server selected by the distribution destination determining section;
the message analyzing section
analyzes a type of a packet transferred from a message communication section and analyzes a type of the message in which a request or a reply is stored,
transmits the request to the distribution destination determining section,
transmits a reply in response to the request sent from the load balancer to the positional information registration section,
transmits a reply to the message communication section in response to the request, the reply being a reply in response to a request other than the request issued from the load balancer, and
notifies a load state analyzing section of the load information of the server sent from the server;
the message communication section
receives a message as a request or a reply transmitted from the user terminal or the server,
transmits the message as a request or a reply transmitted to the user terminal or the server designated by the distribution destination determining section, and
receives a message as a request or a reply transmitted from the user terminal or the server and transmits the message to the message analyzing section;
the load state analyzing section
manages load information sent from the server and notified from the message analyzing section and then notifies the distribution destination determining section of distribution information based on the load information,
notifies the registration information transfer section of information of a server as a candidate for which registration transfer is carried out on the basis of the load information; and
the registration information transfer section notifies the distribution destination determining section of a server as an object of the registration information transfer on the basis of the information of the server for the registration transfer notified from the load state analyzing section and information of the user terminal for which call processing is not being executed in the server contained in the registration transfer server information attained from the distribution destination determining section and of which the registration information exists therein.

12. The load balancer in accordance with claim 1, wherein the server is a Session Initiation Protocol (SIP) server.

13. A network system comprising the load balancer in accordance with claim 1, wherein load is distributed to a plurality of servers.

14. A load balancing method of monitoring load on a plurality of servers connected to a network and for thereby distributing load to the servers, wherein
when a server having load equal to or more than a predetermined threshold value is detected and if there exists a user terminal which is registered to the server and which is not connected thereto for a session, registration of the user terminal is changed from the server to a second server having load less than the predetermined threshold value.

15. A load balancing method for use with a load balancer which is coupled via a network to a plurality of user terminals communicating via a network with each other and which is connected via a network to a plurality of servers each including a function to interface the communication and a positional information registration function to register positional information of the user terminal, the load balancer at least selecting a server to process interface of communication and for thereby distributing load to the servers, comprising:
a message analyzing step of examining a message received from the network and detecting a call connection request message issued from a user terminal on a transmission-side;
a server distribution step of selecting, according to a predetermined algorithm, a server to process the call connection request message and transferring the call connection request message to the server thus selected;
a distribution destination determining step of searching, using an address of a user terminal on a reception side of the call connection request message as a search key, a positional information registration section which stores an address of the user terminal and a server including positional information registration of the user terminal with a correspondence established therebetween, and thereby determining a server including the positional information registration of the reception-side user terminal; and
a registration information transfer step of examining a message received from the network, periodically obtaining load information of the servers, and controlling a change in the correspondence between the address of the user terminal and the server including the positional information registration of the user terminal, on the basis of the load information of the servers and according to a predetermined algorithm.

16. The load balancing method in accordance with claim 15, further comprising a load state analyzing step of managing the load information from the servers, notifying the distribution destination determining step of distribution information based on the load information, and notifying the registration information transfer step of information of a server as a candidate to which a transfer of an entry is to be executed on the basis of the load information.

17. The load balancing method in accordance with claim 15, wherein the message analyzing step comprises:
examining, at reception of a message sent from the user terminal or the server by a message communication step, a type of the message;
transferring the message to the distribution destination determining step if the message is a request;
making a check, if the message is a reply, to determine whether or not the reply is a reply in response to a request issued from the load balancer;
examining a call identifier included in the message from the message communication step;
judging that the reply is a reply in response to the request issued from the load balancer if the call identifier matches call identifier information beforehand notified from the positional information registration section;
transferring the message to the positional information registration section if it is judged that the reply is a reply in response to the request; and
transferring the message to the message communication step if it is judged that the reply is other than a reply in response to the request.

18. The load balancing method in accordance with claim 15 wherein the distribution destination determining step comprises:
receiving a request from the message analyzing step and examines a type of the request;
determining, if the request is a registration request, a server as a distribution destination of the registration request;
determining, if the request is a call connection request, a server as a distribution destination of the call connection request and requesting the positional information registration section to store registration information of a user terminal on a reception-side in the server as a distribution destination, to thereby update distribution information;
extracting a call identifier from the request, if the type of the request is neither a registration request nor a call connection request, and searching a table having stored data pairs each including a call identifier and a distribution destination server to determine a distribution destination server as a distribution destination of the request;
updating the distribution information if the request is a termination request; and
instructing a message communication step to transfer the message to the distribution destination server.

19. The load balancing method in accordance with claim 15, wherein the positional information registration section comprises:
creating a registration request to be sent to a designated server;
notifying a message communication step to transmit the request to a distribution destination server designated by the distribution destination determining step;
issuing a query to the distribution destination server to determine whether or not registration information of a reception-side user terminal exists in the distribution destination server;
calculating, if the registration information is absent, a server storing the registration information of the reception-side user terminal;
obtaining the registration information of the reception-side user terminal from the server of the reception-side user terminal; and
registering the registration information of the reception-side user terminal to the distribution destination server.

20. The load balancing method in accordance with claim 15, wherein a message communication step comprises:
examining a transmission source of a message;
sending, if it is determined that the message is from the inside of the load balancer, the message to a designated destination; and
sending, if it is determined that the message is from the outside of the load balancer, the message to the message analyzing step.

21. The load balancing method in accordance with claim 15, wherein the registration information transfer step comprises:
making a check, based on information of the servers from the load state analyzing step, to determine presence or absence of a server having load equal to or less than a first available threshold value;
setting, if the server is present, the server to a low-load server transfer candidate list;
making a check to determine presence or absence of a server having load equal to or more than a second available threshold value;
making a check, if the server is present, to determine, based on session keep information from the distribution destination determining step, whether or not a user terminal for which call processing is not been executed in the server has been registered thereto;
setting, if the user terminal has been registered, a data pair including the server and registration information of the user terminal to a high-load server transfer registration list;
selecting a high-load server as an object of registration information transfer processing, registration information of a user terminal, and a low-load server from the data pairs each including a high-load server and registration information of a user terminal in the high-load server transfer registration list and the servers in the low-load server transfer candidate list; and
instructing the distribution destination determining step to execute transfer processing.

22. A storage medium for storing a program for making a computer, included in a load balancer for monitoring load on a plurality of servers connected to a network and for thereby distributing load to the servers, execute processing wherein
when a server having load equal to or more than a predetermined threshold value is detected and if there exists a user terminal which is registered to the server and which is not connected thereto for a session, the load balancer changes registration of the user terminal from the server to a second server having load less than the predetermined threshold value.

23. A storage medium for storing a program for making a computer, included in a load balancer which is coupled via a network to a plurality of user terminals communicating via a network with each other and which is connected via a network to a plurality of servers each including a function to interface the communication and a positional information registration function to register positional information of the user terminal, the load balancer at least selecting a server to process interface of communication and for thereby distributing load to the servers, execute:
message analyzing processing for examining a message received from the network and detecting a call connection request message issued from a user terminal on a transmission-side;
server distribution processing for selecting, according to a predetermined algorithm, a server to process the call connection request message and transferring the call connection request message to the server thus selected;
distribution destination determining processing for searching, using an address of a user terminal on a reception-side of the call connection request message as a search key, a positional information registration section which stores an address of the user terminal and a server including positional information registration of the user terminal with a correspondence established therebetween, and thereby determining a server including the positional information registration of the reception-side user terminal; and
registration information transfer processing for examining a message received from the network, periodically obtaining load information of the servers, and controlling a change in the correspondence between the address of the user terminal and the server including the positional information registration of the user terminal, on the basis of the load information of the servers and according to a predetermined algorithm.

24. The storage medium for storing the program in accordance with claim 23, further making the computer execute load state analyzing processing for managing the load information from the servers, notifying the distribution destination determining processing of distribution information based on the load information, and notifying the registration information transfer processing of information of a server as a candidate to which a transfer of an entry is to be executed on the basis of the load information.

25. The storage medium for storing the program in accordance with claim 23, wherein the message analyzing processing comprises:
examining, at reception of a message sent from the user terminal or the server by a message communication section, a type of the message;
transferring the message to the distribution destination determining processing if the message is a request;
making a check, if the message is a reply, to determine whether or not the reply is a reply in response to a request issued from the load balancer;
examining a call identifier included in the message from message communication processing;
judging that the reply is a reply in response to the request issued from the load balancer if the call identifier matches call identifier information beforehand notified from positional information registration processing;
transferring the message to the positional information registration processing if it is judged that the reply is a reply in response to the request; and
transferring the message to the message communication processing if it is judged that the reply is other than a reply in response to the request.

26. The storage medium for storing the program in accordance with claim 23, wherein the distribution destination determining processing comprises:
receiving a request from the message analyzing processing and examines a type of the request;
determining, if the request is a registration request, a server as a distribution destination of the registration request;
determining, if the request is a call connection request, a server as a distribution destination of the call connection request and requesting positional information registration processing to store registration information of a user terminal on a reception side in the server as a distribution destination, to thereby update distribution information;
extracting a call identifier from the request, if the type of the request is neither a registration request nor a call connection request, and searching a table having stored data pairs each including a call identifier and a distribution destination server to determine a distribution destination server as a distribution destination of the request;
updating the distribution information if the request is a termination request; and
instructing message communication processing to transfer the message to the distribution destination server.

27. The storage medium for storing the program in accordance with claim 23, wherein positional information registration processing comprises:
creating a registration request to be sent to a designated server;
notifying message communication processing to transmit the request to a distribution destination server designated by the distribution destination determining processing;
issuing a query to the distribution destination server to determine whether or not registration information of a reception-side user terminal exists in the distribution destination server;
calculating, if the registration information is absent, a server storing the registration information of the reception-side user terminal;
obtaining the registration information of the reception-side user terminal from the server of the reception-side user terminal; and
registering the registration information of the reception-side user terminal to the distribution destination server.

28. The storage medium for storing the program in accordance with claim 23, wherein message communication processing comprises:
examining a transmission source of a message;
sending, if it is determined that the message is from the inside of the load balancer, the message to a designated destination; and
sending, if it is determined that the message is from the outside of the load balancer, the message to the message analyzing processing.

29. The storage medium for storing the program in accordance with claim 23, wherein the registration information transfer processing comprises:
making a check, based on information of the servers from the load state analyzing processing, to determine presence or absence of a server having load equal to or less than a first available threshold value;
setting, if the server is present, the server to a low-load server transfer candidate list;
making a check to determine presence or absence of a server having load equal to or more than a second available threshold value;
making a check, if the server is present, to determine, based on session keep information from the distribution destination determining processing, whether or not a user terminal for which call processing is not been executed in the server has been registered thereto;
setting, if the user terminal has been registered, a data pair including the server and registration information of the user terminal to a high-load server transfer registration list;
selecting a high-load server as an object of registration information transfer processing, registration information of a user terminal, and a low-load server from the data pairs each including a high-load server and registration information of a user terminal in the high-load server transfer registration list and the servers in the low-load server transfer candidate list; and
instructing the distribution destination determining processing to execute transfer processing.
